(19) United States
(12) Patent Application Publication
(10) Pub. No.: US 2007/0252969 A1
(43) Pub. Date: Nov. 1, 2007

(54) Stage apparatus and exposure apparatus

(75) Inventor: Masashi Ueno, Tokyo (JP)

Correspondence Address: OSHA LIANG L.L.P., 1221 MCKINNEY STREET, SUITE 2800, HOUSTON, TX, 77010, US

(73) Assignee: Advantest Corporation, Tokyo (JP)

(21) Appl. No.: 11/251,572

(22) Filed: Oct. 14, 2005

Related U.S. Application Data
(63) Continuation of application No. PCT/JP04/01765, filed on Feb. 18, 2004.

(30) Foreign Application Priority Data
Apr. 18, 2003 (JP) 2003-114524

(51) Int. Cl. G03B 27/58

(52) U.S. Cl. 355/72

(57) ABSTRACT

A stage apparatus for driving and moving a target object comprises: a movable slider for mounting and moving the target object; a movable-slider driving unit for driving the movable slider; a feedforward compensator for calculating the driving amount to be generated by the movable slider driving unit over the period of time during the movement of the movable slider from the start position up to the target position to which the movable slider is to be moved, based upon the start position and the target position; a movable-slider position sensor for detecting the position of the movable slider; a feedback compensator for calculating the driving amount to be generated by the movable slider driving unit over the period of time during the movement of the movable slider from the start position up to the target position, based upon the target position to which the movable slider is to be moved, and the position of the movable slider detected by the movable-slider position sensor.

### CROSS REFERENCE TO RELATED APPLICATION

This is a continuation application of PCT/JP2004/001765 filed on Feb. 18, 2004 which claims priority from a Japanese Patent Application No. 2003-114524 filed on Apr. 18, 2003, the contents of which are incorporated herein by reference.

### BACKGROUND OF THE INVENTION

1. Field of the invention

The present invention relates to a stage apparatus and an exposure apparatus. In particular, the present invention relates to an exposure apparatus for exposing a wafer and a stage apparatus for mounting a wafer on the exposure apparatus.

2. Related art

Conventionally, exposure apparatuses for exposing a wafer are widely used, having a function of moving the wafer using a wafer stage having wheel-driven-type driving means including a ball bearing. Also, recently, a wafer stage has been proposed which has a function of moving a wafer with high precision using a pneumatic actuator as described in Japanese Unexamined Patent Application Publication No. 2002-184686, for example.

In recent years, improved fine processing technology for semiconductor devices requires even higher exposure precision of exposure apparatuses. In order to improve the exposure precision of the exposure apparatus, improving the driving precision of a wafer stage for mounting and moving a wafer is of great importance.

Accordingly, it is an object of the present invention to provide a stage apparatus and an exposure apparatus capable of solving the aforementioned problems. The aforementioned object is realized by a combination of features described in the independent Claims. Furthermore, dependent Claims provide specific arrangements having further advantages.

### SUMMARY OF THE INVENTION

In order to solve the aforementioned problems, a stage apparatus for driving and moving a target object according to a first aspect of the present invention comprises: a movable slider for mounting and moving the target object; a movable-slider driving unit for driving the movable slider; a feedforward compensator for calculating a feedforward driving amount which is a driving amount to be generated by the movable slider driving unit over the period of time during the movement of the movable slider from the start position up to the target position to which the movable slider is to be moved, based upon the start position and the target position; a movable-slider position sensor for detecting the position of the movable slider; a feedback compensator for calculating a feedback driving amount which is a driving amount to be generated by the movable slider driving unit over the period of time during the movement of the movable slider from the start position up to the target position, based upon the target position to which the movable slider is to be moved, and the position of the movable slider detected by the movable-slider position sensor.

A stage apparatus may further include a target position filter for calculating the filtering target position which is an ideal position of the movable slider driving unit over the period of time during the movement of the movable slider from the start position up to the target position based upon the start position of the movable slider and the target position to which the movable slider is to be moved. With such an arrangement, the feedback compensator may calculate the feedback driving amount over the period of time during the movement of the movable slider from the start position up to the target position based upon the filtering target position calculated by the target position filter and the position of the movable slider detected by the movable-slider position sensor.

The feedforward compensator may calculate the feedforward driving amount using a composite function formed of a first function for calculating the position of the movable slider from the point in time, and a second function for calculating a driving amount to be generated by the movable slider driving unit from the position of the movable slider. Furthermore, the second function may be represented by a function in the Laplace space in which the inversion of Laplace transform thereof creates a divergent function. Furthermore, first function may be represented by a function for creating the composite function in which the inversion of Laplace transform thereof creates a convergent function. Furthermore, the target position filter may calculate a filtering target position which is the position of the movable slider driving unit over the period of time during the movement of the movable slider from the start position up to the target position using the first function.

The stage apparatus may further include an acceleration sensor provided to the movable slider for detecting the acceleration of the movable slider. With such an arrangement, the feedback compensator may calculate the feedback driving amount based upon the target position to which the movable slider is to be moved, the position of the movable slider detected by the movable-slider position sensor, and the acceleration of the movable slider detected by the acceleration sensor.

The stage apparatus may further include: a fixed guide shaft for guiding the movable slider; a pressure plate provided between the movable slider and the fixed guide shaft; two cylinder chambers formed by the movable slider and the fixed guide shaft so as to be arranged in the horizontal direction with the pressure plate introduced therebetween; and two pressure sensors for detecting the pressures in the two cylinder chambers. With such an arrangement, the feedback compensator may calculate the feedback driving amount based upon the target position to which the movable slider is to be moved, the position of the movable slider detected by the movable-slider position sensor, and the pressures in the two cylinder chambers detected by the two pressure sensors, respectively.

An electron-beam exposure apparatus for exposing a wafer according to a second aspect of the present invention comprises: and a stage apparatus for mounting and moving the wafer; an exposure unit for exposing the wafer mounted on the stage apparatus. Furthermore, the stage apparatus includes: a movable slider for mounting and moving the wafer; a movable-slider driving unit for driving the movable slider; a feedforward compensator for calculating a feedforward driving amount which is a driving amount to be generated by the movable slider driving unit over the period of time during the movement of the movable slider from the start position up to the target position to which the movable slider is to be moved, based upon the start position and the target position; a movable-slider position sensor for detecting the position of the movable slider; and a feedback compensator for calculating a feedback driving amount which is a driving amount to be generated by the movable slider driving unit over the period of time during the movement of the movable slider from the start position up to the target position, based upon the target position to which the movable slider is to be moved, and the position of the movable slider detected by the movable-slider position sensor.

A stage apparatus for driving and moving a target object according to a third aspect of the present invention comprises: a movable slider for mounting and moving the target object; a movable slider driving unit for driving the movable slider; a movable-slider position sensor for detecting the position of the movable slider; an acceleration sensor provided to the movable slider for detecting the acceleration of the movable slider; and a movable-slider position compensator for controlling the driving amount generated by the movable slider driving unit, based upon the target position to which the movable slider is to be moved, the position of the movable slider detected by the movable-slider position sensor, and the acceleration of the movable slider detected by the acceleration sensor.

The stage apparatus may further include: a fixed guide shaft for guiding the movable slider; a pressure plate provided between the movable slider and the fixed guide shaft; and two cylinder chambers which is formed by the movable slider and the fixed guide shaft so as to be arranged in the horizontal direction with the pressure plate introduced therebetween, and which allows movement of the movable slider along the fixed guide shaft by controlling the internal pressure using the movable slider driving unit. With such an arrangement, the acceleration sensor may be provided within either of the two cylinder chambers. Wiring for electrically connecting the acceleration sensor and the movable-slider position compensator may be embedded within the fixed guide shaft.

The stage apparatus may further include an image analysis unit for capturing an image and performing image analysis. With such an arrangement, the acceleration sensor may display the acceleration of the movable slider thus detected. Furthermore, the image analysis unit may capture an image of the acceleration of the movable slider displayed by the acceleration sensor and perform image analysis so as to obtain the acceleration of the movable slider and output the acceleration to the movable-slider position compensator.

An electron-beam exposure apparatus for exposing a wafer according to a fourth aspect of the present invention comprises: a stage apparatus for mounting and moving the wafer; and an exposure unit for exposing the wafer mounted on the stage apparatus. Furthermore, the stage apparatus includes: a movable slider for mounting and moving the wafer; a movable-slider driving unit for driving the movable slider; a movable-slider position sensor for detecting the position of the movable slider; an acceleration sensor provided to the movable slider for detecting the acceleration of the movable slider; and a movable-slider position compensator for controlling the driving amount to be generated by the movable slider driving unit, based upon the target position to which the movable slider is to be moved, the position of the movable slider detected by the movable-slider position sensor, and the acceleration of the movable slider detected by the acceleration sensor.

A stage apparatus for driving and moving a target object according to a fifth aspect of the present invention comprises: a movable slider for mounting and moving the target object; a fixed guide shaft for guiding the movable slider; a pressure plate provided between the movable slider and the fixed guide shaft; two cylinder chambers formed by the movable slider and the fixed guide shaft so as to be arranged in the horizontal direction with the pressure plate introduced therebetween; a movable-slider driving unit for driving the movable slider along the fixed guide shaft by controlling the pressures in the two cylinder chambers; a movable-slider position sensor for detecting the position of the movable slider; two pressure sensors for detecting the pressures in the two cylinder chambers, respectively; and a pressure compensator for controlling the driving amount to be generated by the movable-slider driving unit based upon the target position to which the movable slider is to be moved, the position of the movable slider detected by the movable-slider position sensor, and the pressures in the two cylinder chambers detected by the two pressure sensors, respectively.

The two pressure sensors may be provided within the two cylinder chambers, respectively. The two pressure sensors may be fixed on both the left and right faces of the pressure plate. Wiring for electrically connecting the pressure sensor and the pressure compensator may be embedded within the fixed guide shaft.

An electron-beam exposure apparatus for exposing a wafer according to a sixth aspect of the present invention comprises: a stage apparatus for mounting and moving the wafer; and an exposure unit for exposing the wafer mounted on the stage apparatus. Furthermore, the stage apparatus includes: a movable slider for mounting and moving the wafer; a fixed guide shaft for guiding the movable slider; a pressure plate provided between the movable slider and the fixed guide shaft; two cylinder chambers formed by the movable slider and the fixed guide shaft so as to be arranged in the horizontal direction with the pressure plate introduced therebetween; a movable-slider driving unit for driving the movable slider along the fixed guide shaft by controlling the pressures in the two cylinder chambers; a movable-slider position sensor for detecting the position of the movable slider; two pressure sensors for detecting the pressures in the two cylinder chambers, respectively; and a pressure compensator for controlling the driving amount to be generated by the movable-slider driving unit based upon the target position to which the movable slider is to be moved, the position of the movable slider detected by the movable-slider position sensor, and the pressures in the two cylinder chambers detected by the two pressure sensors, respectively.

Note that the summary of the present invention described above is not a comprehensive listing of all the features required for the present invention; rather, various sub-combinations of the aforementioned features are also encompassed in the present invention.

### BRIEF DESCRIPTION OF THE DRAWINGS

FIG. 1 shows an example of the configuration of an electron-beam exposure apparatus 100.

FIG. 2 shows an example of the configuration of the wafer stage 46.

FIG. 3 shows an example of the configuration of a stage guide 66.

FIG. 4 shows a first example of the configuration of a wafer stage control unit 96.

FIG. 5 shows an example of an acceleration sensor 302 according to the first example.

FIG. 6 shows a second example of the wafer stage control unit 96.

FIG. 7 shows a third example of the configuration of the wafer stage control unit 96 according to a third example.

FIG. 8 shows an example of pressure sensors 336a and 336b according to the third example.

FIG. 9 shows a fourth example of the configuration of the wafer stage control unit.

FIG. 10 shows an example of the relation between change in the position of a movable slider 200 and the point in time according to the fourth example.

### DETAILED DESCRIPTION OF THE INVENTION

Description will be made below regarding the present invention with reference to the following embodiments. It should be understood that the following embodiments do not restrict the present invention according to the Claims. Furthermore, not all of the combinations of the features described in the embodiments are necessarily indispensable to the solving means of the present invention.

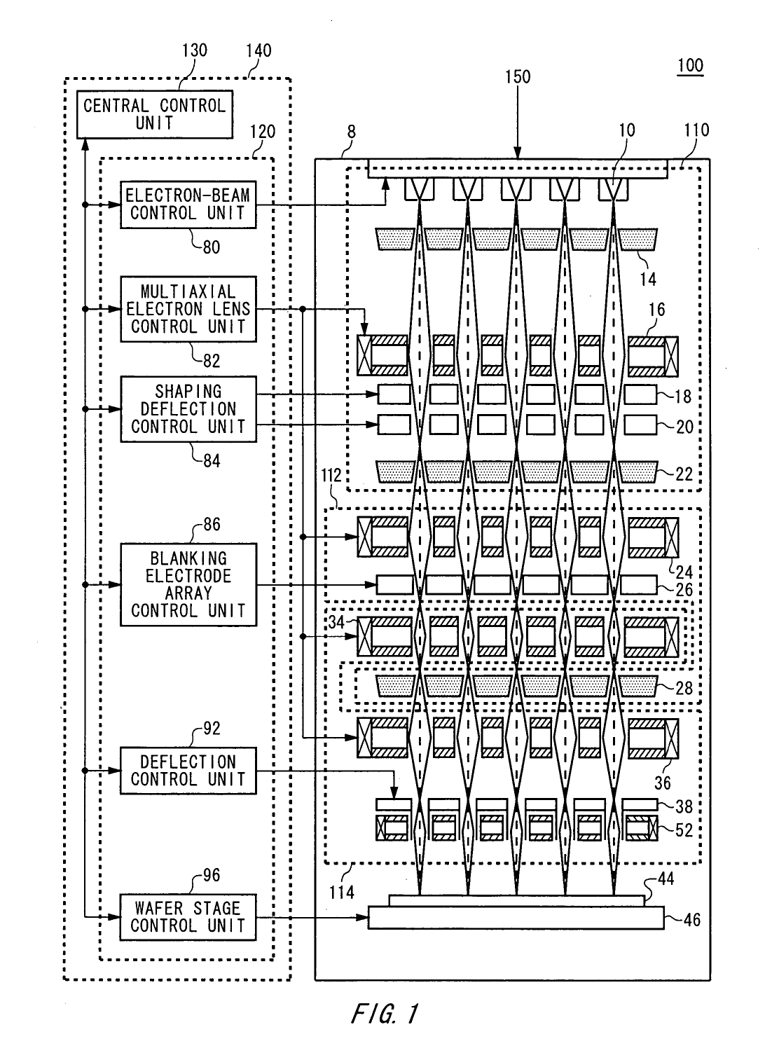

FIG. 1 shows an example of the configuration of an electron-beam exposure apparatus 100 according to an embodiment of the present invention. The electron-beam exposure apparatus 100 includes an exposure unit 150 for performing predetermined exposure processing for a wafer 44 using electron beams, and a control unit 140 for controlling the operation of each component included in the exposure unit 150.

The exposure unit 150 has an electron optical system within a casing 8. The electron optical system includes: an electron-beam shaping means 110 for generating multiple electron beams and shaping the electron beams with a desired cross-section; an exposure switching means 112 having a function of switching whether or not each of the multiple electron beams is to be cast onto the wafer 44; and a wafer-pattern projecting means 114 for adjusting the direction and the size of a pattern image to be projected onto the wafer 44. Furthermore, the exposure unit 150 includes a wafer stage 46 for mounting the wafer 44 to be exposed so as to form a pattern thereon. The wafer 44 is an example of a target object to be moved, for description in the present invention.

The electron-beam shaping means 110 include: multiple electron guns 10 for generating multiple electron beams; a first shaping member 14 and a second shaping member 22 having multiple apertures which allow the electron beams to pass through with a predetermined cross-section; a first multiaxial electron lens 16 for converging the multiple electron beams independent of one another and adjusting the focus of each electron beam; a first shaping deflection unit 18 and a second shaping deflection unit 20 for deflecting multiple electron beams, which have passed trough the first shaping member 14, independent of one another.

The exposure switching means 122 include: a second multiaxial electron lens 24 for converging multiple electron beams independent of one another, and adjusting the focus of each electron beam; a blanking electrode array 26 having a function of deflecting the multiple electron beams independent of one another, thereby enabling switching of whether or not each electron beam is to be cast onto the wafer 44; and an electron-beam shielding member 28 having multiple apertures which allow the undeflected electron beams to pass through while shielding the electron beams deflected by the blanking electrode array 26. Also, an arrangement may be made which employs a blanking aperture array instead of the blanking electrode array 26.

The wafer-pattern projecting means 114 include: a third multiaxial electron lens 34 for converging multiple electron beams independent of one another and reducing the exposure diameter of each electron beam; a fourth multiaxial electron lens 36 for converging the multiple electron beams independent of one another, and adjusting the focus of each electron beam; a deflection unit 38 for deflecting each of the multiple electron beams independent of one another, toward a desired position on the wafer 44; and a fifth multiaxial electron lens 52 serving as an objective lens for the wafer 44, and having a function of converging the multiple electron beams independent of one another.

The control unit 140 includes a central control unit 130 and a sub-unit control unit 120. The sub-unit control unit 120 includes an electron-beam control unit 80, a multiaxial electron lens control unit 82, a shaping deflection control unit 84, a blanking electrode array control unit 86, a deflection control unit 92, and a wafer stage control unit 96. The central control unit 130 is a workstation, for example, and has a function of centrally controlling each control unit included in the sub-unit control unit 120.

The electron-beam control unit 80 controls the electron guns 10. The multiaxial electron lens control unit 82 controls currents supplied to the first multiaxial electron lens 16, the second multiaxial electron lens 24, the third multiaxial electron lens 34, the fourth multiaxial electron lens 36, and the fifth multiaxial electron lens 52. The shaping deflection control unit 84 controls the first shaping deflection unit 18 and the second shaping deflection unit 20. The blanking electrode array control unit 86 controls the voltages to be applied to the deflection electrodes included in the blanking electrode array 26. The deflection control unit 92 controls the voltages to be applied to deflection electrodes included in multiple deflectors included in the deflection unit 38. The wafer stage control unit 96 controls the wafer stage 46 to be moved up to a desired position. Note that the wafer stage 46 and the wafer stage control unit 96 are an example of the stage apparatus according to the present invention.

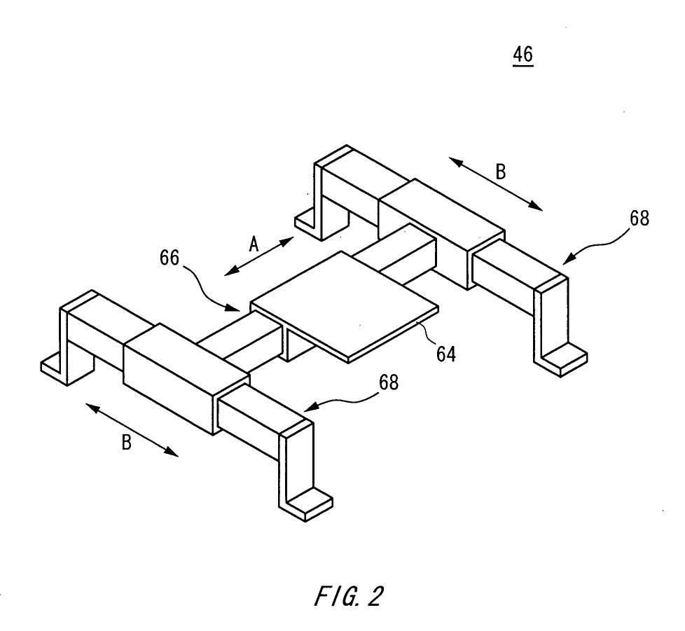

FIG. 2 shows an example of the configuration of the wafer stage 46 according to the present embodiment. The wafer stage 46 includes a wafer mounting table 64 for mounting the wafer 44, a stage guide 66 for guiding the wafer mounting table 64 in a predetermined direction A, and a pair of guide rails 68 for guiding the stage guide 66 in a direction B generally orthogonal to the aforementioned predetermined direction A. The guide rails 68 have a structure which allows engagement thereof with both ends of the stage guide 66. Each of the stage guide 66 and the guide rails 68 comprises a pneumatic actuator. Thus, the wafer stage 46 comprises three pneumatic actuators, and has a function of controlling two-dimensional movement of the wafer 44.

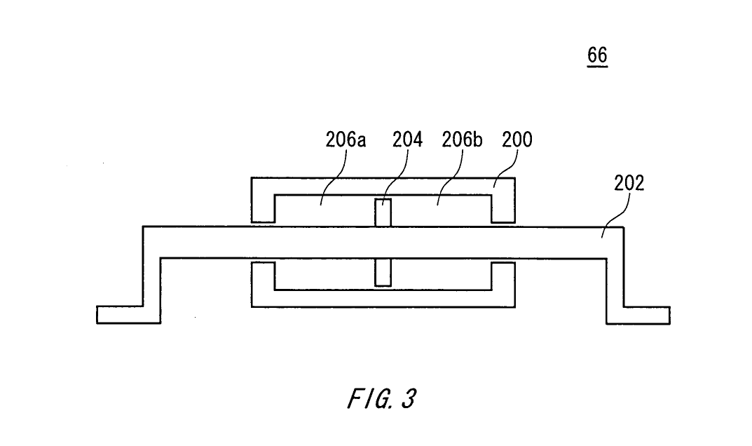

FIG. 3 shows an example of the configuration of the stage guide 66 according to the present embodiment. Note that the guide rails 68 have the same configuration and perform the same operation as those of the stage guide 66 described below, and accordingly, description thereof will be omitted.

The stage guide 66 includes: a movable slider 200 for mounting and moving the wafer 44; a fixed guide shaft 202 for guiding the movable slider 200; and a pressure plate 204 provided between the movable slider 200 and the fixed guide shaft 202. With such a structure, the movable slider 200 and the fixed guide shaft 202 form two cylinder chambers 206a and 206b arranged in the horizontal direction with the pressure plate 204 introduced therebetween.

With the present embodiment, the internal pressure of each of the two cylinder chambers 206a and 206b is controlled. Thus, the present embodiment has a function of controlling difference in the pressure between the cylinder chambers 206a and 206b. This enables the movable slider 200 to move linearly along the fixed guide shaft 202 in a non-contact manner. Specifically, upon introducing compressed air into the cylinder chamber 206a while discharging compressed air from the cylinder 206b. In this case, the pressure in the cylinder chamber 206a becomes greater than that in the cylinder chamber 206b. This moves the movable slider 200 in the direction from the cylinder chamber 206b to the cylinder chamber 206a. Conversely, upon introducing compressed air into the cylinder chamber 206b while discharging compressed air from the cylinder chamber 206a. In this case, the pressure in the cylinder chamber 206b becomes greater than that in the cylinder chamber 206a. This moves the movable slider 200 in the direction from the cylinder chamber 206a to the cylinder chamber 206b.

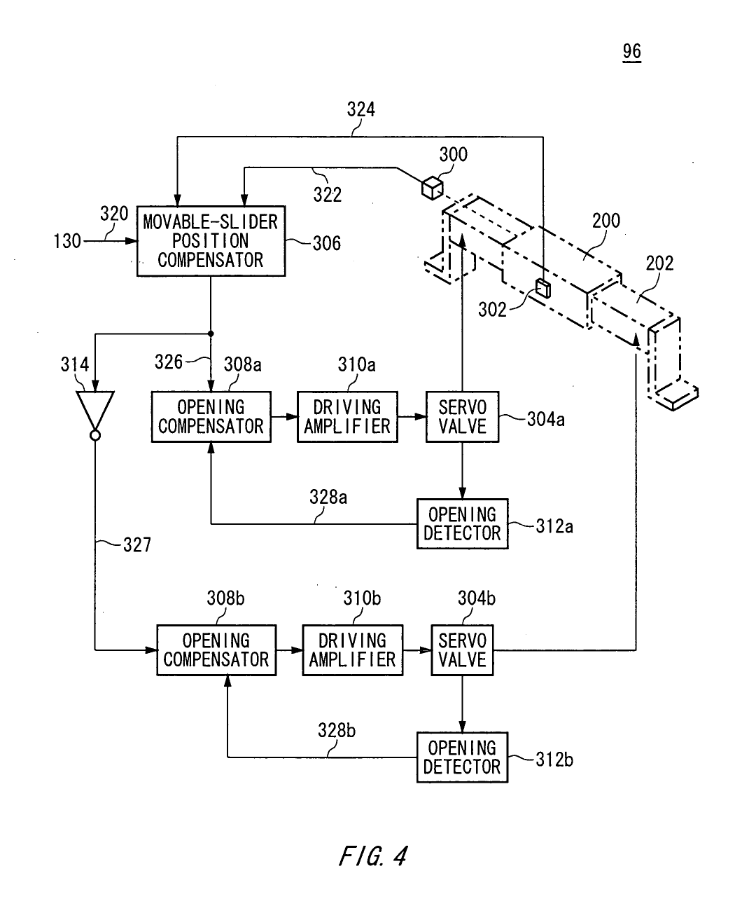

FIG. 4 shows a first example of the configuration of the wafer stage control unit 96 according to the present embodiment. The wafer stage control unit 96 includes: a movable-slider position sensor 300 for detecting the position of the movable slider 200; an acceleration sensor 302, provided to the movable slider 200, for detecting the acceleration of the movable slider 200; servo valves 304a and 304b which are an example of a movable slider driving unit for driving the movable slider 200; a movable-slider position compensator 306 for controlling the driving amount which is generated by the servo valves 304a and 304b and which is applied to the movable slider 200; opening compensators 308a and 308b for adjusting the openings of the servo valves 304a and 304b, respectively; driving amplifiers 310a and 310b for amplifying electric power supplied to the servo valves 304a and 304b, respectively; and opening detectors 312a and 312b for detecting the opening of the servo valves 304a and 304b.

The movable-slider position compensator 306 acquires a target position signal 320, which indicates the target position to which the movable slider 200 is to be moved, from the central control unit 130. Furthermore, the movable-slider position compensator 306 acquires a movable-slider position signal 322 which indicates the position of the movable slider 200 and which has been detected by the movable-slider position sensor 300. Furthermore, the movable-slider position compensator 306 acquires a movable-slider acceleration signal 324, which indicates the acceleration of the movable slider 200 and which has been detected by the acceleration sensor 302, from the acceleration sensor 302. Then, the movable-slider position compensator 306 outputs a servo-valve opening instruction value 326 for controlling the opening of the servo valves 304a and 304b, determined based upon the target position to which the movable slider 200 is to be moved, the position of the movable slider 200, and the acceleration of the movable slider 200.

The opening compensator 308a acquires the servo-valve opening instruction value 326 from the movable-slider position compensator 306. Furthermore, the opening compensator 308a acquires an opening detection signal 328a, which indicates the opening of the servo valve 304a and which has been detected by the opening detector 312a, from the opening detector 312a. Then, the opening compensator 308a adjusts the opening of the servo valve 304a according to the servo valve opening instruction value 326 and the opening detection signal 328a. Thus, the servo valve 304a adjusts introduction/discharge of compressed air into/from the cylinder chamber 206a.

The opening compensator 308b acquires the servo valve opening instruction value 327 from an inverter 314. Here, the inverter 314 inverts the servo valve opening instruction value 326 output from the movable-slider position compensator 306, into the servo valve opening instruction valve 327. Furthermore, the opening compensator 308b acquires an opening detection signal 328b, which indicates the opening of the servo valve 304b and which has been detected by the opening detector 312b, from the opening detector 312b. Then, the opening compensator 308b adjusts the opening of the servo valve 304b according to the servo valve opening instruction value 327 and the opening detection signal 328b. Thus, the servo valve 304b adjusts introduction/discharge of compressed air into/from the cylinder chamber 206b.

Note that the stage guide 66 includes piping for introduction/discharge of compressed air into/from the cylinder chambers 206a and 206b. Also, the stage guide 66 may includes wiring provided along the piping, for electrically connecting the acceleration sensor 302 and the movable-slider position compensator 306.

With the wafer stage control unit 96 according to the present embodiment, the acceleration of the movable slider 200 is detected by the acceleration sensor 302 directly mounted to the movable slider 200. Such an arrangement has the advantage of enabling control of the movable slider 200 with high precision corresponding to the acceleration thereof as compared with an arrangement in which the acceleration of the movable slider 200 is calculated by differentiating change in the position of the movable slider 200 detected by the movable-slider position sensor 300. Specifically, an arrangement in which the acceleration of the movable slider 200 is calculated by differentiating change in the position of the movable slider 200 has the disadvantage of reduction in the control performance due to high-frequency noise involved in the differentiated signal and delay involved in computation processing for the differentiated signal. On the other hand, the wafer stage control unit 96 according to the present embodiment is freed from all such deteriorative factors. This improves the control performance of the wafer stage 46, thereby improving the exposure precision of the electron-beam exposure apparatus 100.

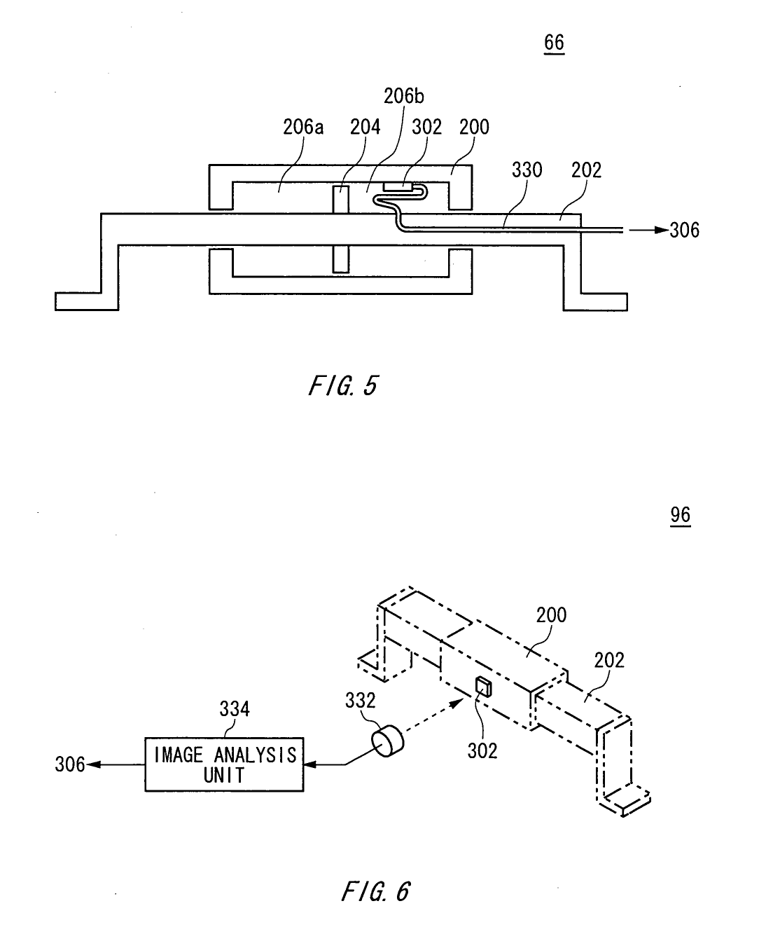

FIG. 5 shows an example of the acceleration sensor 302 according to a first example of the present embodiment. The acceleration sensor 302 is preferably provided within either of the two cylinder chambers 206a or 206b. Furthermore, wiring 330 for electrically connecting the acceleration sensor 302 and the movable-slider position compensator 306 is preferably embedded within the fixed guide shaft 202.

The wafer stage 46 is placed within a chamber with an extremely high degree of vacuum. Accordingly, insertion of the acceleration sensor 302 and so forth leads to a risk of reduced vacuum due to a foreign matter contained therein. With the present example, the acceleration sensor 302 is provided within either of the cylinder chamber 206a or 206b. This enables the acceleration sensor 302 to be attached to the movable slider 200 without such a risk of reducing vacuum in the chamber. Furthermore, such an arrangement in which the wiring 330 is embedded within the fixed guide shaft 202 has the advantage of suppressing the adverse effects on the path of the electron beam. This improves the exposure precision of the electron-beam exposure apparatus 100. Note that a magnetic shield is preferably formed so as to surround the wiring 330, regardless of whether or not the wiring 330 is embedded within the fixed guide shaft 202.

FIG. 6 shows a second example of the wafer stage control unit 96 according to the present embodiment. The same components and operation of the wafer stage control unit 96 according to the present example as those of the wafer stage control unit 96 according to the first example shown in FIG. 4 will be omitted. Now, description will be made regarding only the differences therebetween.

The wafer stage control unit 96 according to the present example further includes an image-capturing unit 332 and an image analysis unit 334, as well as the components shown in FIG. 4. The acceleration sensor 302 displays the detected acceleration of the movable slider 200. Then, the image-capturing unit 332 takes an image of the acceleration of the movable slider 200 displayed by the acceleration sensor 302. Then, the image analysis unit 334 acquires the image taken by the image-capturing unit 332, and analyzes the image so as to acquire the acceleration of the movable slider 200. The acceleration thus acquired is output to the movable-slider position compensator 306.

For example, the acceleration sensor 302 indicates the acceleration of the movable slider 200 using a pendulum provided so as to allow an external device to visually confirm the state of the pendulum. With such an arrangement, the image analysis unit 334 analyzes the image of the acceleration sensor 302 taken by the image-capturing unit 332, thereby detecting the deflection angle of the pendulum. Also, an arrangement may be made in which the acceleration sensor 302 displays the value of the detected acceleration of the movable slider 200 on a display unit provided so as to allow external devices to visually confirm the value. With such an arrangement, the image analysis unit 334 analyzes the image displayed on the display unit of the acceleration sensor 302 taken by the image-capturing unit 332, thereby detecting the value of the acceleration of the movable slider 200.

With the wafer stage control unit 96 according to the present example, the acceleration of the movable slider 200 detected by the acceleration sensor 302 is detected without connecting the acceleration sensor 302 and the movable-slider position compensator 306 via wiring. This eliminates the adverse effects on the paths of the electron beams due to wiring, thereby improving the exposure precision of the electron-beam exposure apparatus 100.

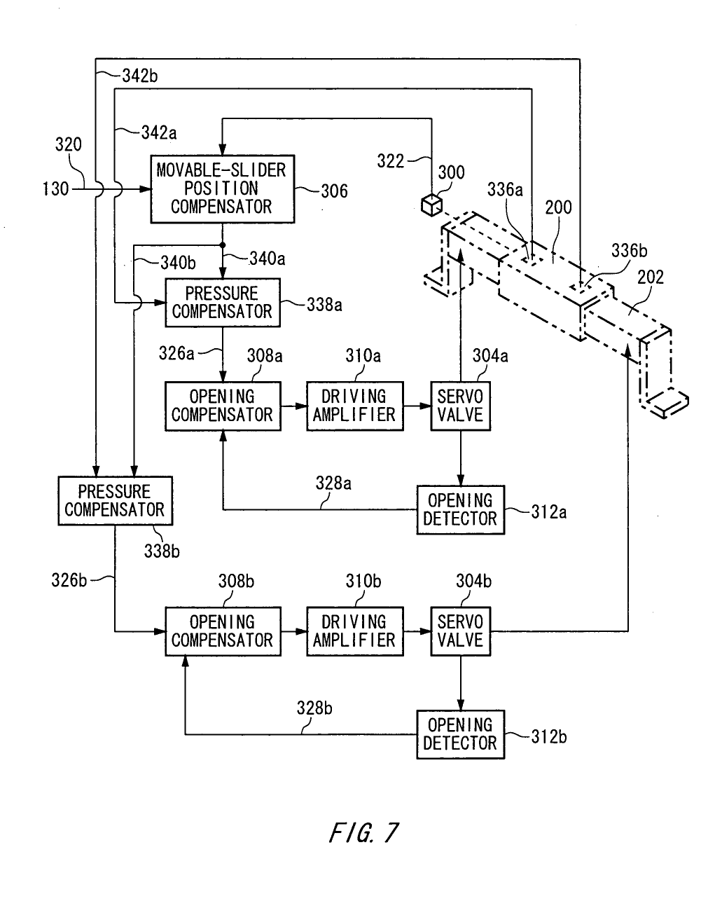

FIG. 7 shows a third example of the configuration of the wafer stage control unit 96 according to the present embodiment. The wafer stage control unit 96 according to the present example includes: the movable-slider position sensor 300 for detecting the position of the movable slider 200; two pressure sensors 336a and 336b for detecting the pressure in the two cylinder chambers 206a and 206b; the two servo valves 304a and 304b for driving the movable slider 200; the movable-slider position compensator 306 for controlling the driving amount of the movable slider 200, which is generated by the servo valves 304a and 304b; pressure compensators 338a and 338b for controlling the driving amount of the movable slider 200 based upon the pressure in the cylinder chambers 206a and 206b detected by the pressure sensors 336a and 336b; the opening compensators 308a and 308b for adjusting the opening of the servo valves 304a and 304b under control of the pressure compensators 338a and 338b; the driving amplifiers 310a and 310b for amplifying the electric power supplied to the servo valves 304a and 304b, respectively, and the opening detectors 312a and 312b for detecting the opening of the servo valves 304a and 304b.

The movable slider position compensator 306 acquires the target position signal 320, which indicates the target position to which the movable slider 200 is to be moved, from the central control unit 130. Furthermore, the movable-slider position compensator 306 acquires the movable-slider position signal 322 which indicates the position of the movable slider 200 detected by the movable-slider position sensor 300. Then, the movable-slider position compensator 306 outputs cylinder-chamber internal-pressure instruction values 340a and 340b for controlling the pressure in the two cylinder chambers 206a and 206b based upon the target position to which the movable slider 200 is to be moved, and the position of the movable slider 200.

The pressure compensators 338a and 338b acquire the cylinder-chamber internal-pressure instruction values 340a and 340b from the movable-slider position compensator 306, respectively. Furthermore, the pressure compensators 338a and 338b acquire pressure signals 342a and 342b indicating the pressure in the two cylinder chambers 206a and 206b detected by the two pressure sensors 336a and 336b, respectively. Then, the pressure compensators 338a and 338b output servo-valve opening instruction values 326a and 326b for controlling the opening of the servo valves 304a and 304b based upon the cylinder-chamber internal-pressure instruction values 340a and 340b, and the pressure signals 342a and 342b, respectively.

The opening compensators 308a and 308b acquire the servo-valve opening instruction values 326a and 326b from the pressure compensators 338a and 338b, respectively. Furthermore, the opening compensators 308a and 308b acquire the opening detection signals 328a and 328b which indicate the opening of the servo valves 304a and 304b and which are detected by the opening detectors 312a and 312b, respectively. Then, the opening compensators 308a and 308b adjust the opening of the servo valves 304a and 304b based upon the servo valve instruction values 326a and 326b, and the opening detection signals 328a and 328b, respectively. Thus, the servo valves 304a and 304b adjust introduction/discharge of compressed air into/from the cylinder chambers 206a and 206b, respectively.

Note that the stage guide 66 includes piping for introduction/discharge of compressed air into/from the cylinder chambers 206a and 206b. Also, wiring for electrically connecting the pressure sensors 336a and 336b, and the movable-slider position compensator 306 may be provided along the piping.

With the wafer stage control unit 96 according to the present example, the pressure in the cylinder chambers 206a and 206b is directly detected, and is used as feedback signals for controlling the pressure. Thus, this improves the responsivity to change in the pressure in the cylinder chambers 206a and 206b. This improves the control performance of the wafer stage 46, thereby improving the exposure precision of the electron-beam exposure apparatus 100.

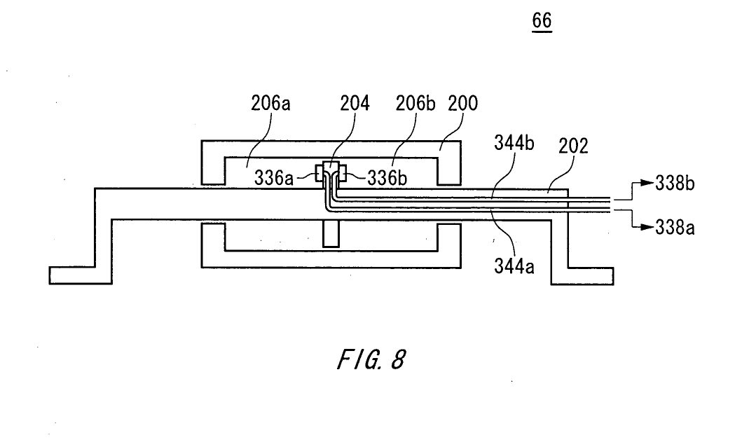

FIG. 8 shows an example of the pressure sensors 336a and 336b according to the third example of the present embodiment. The two pressure sensors 336a and 336b are included within the two cylinder chambers 206a and 206b, respectively. Furthermore, the two pressure sensors 336a and 336b are preferably fixed to both left and right faces of the pressure plate 204, respectively. Furthermore, wiring 344a for electrically connecting the pressure sensor 336a and the pressure compensator 338a, and wiring 344b for electrically connecting the pressure sensor 336b and the pressure compensator 338b are preferably embedded within the pressure plate 204 and the fixed guide shaft 202.

Such an arrangement in which the wiring 344a and 344b are embedded within the pressure plate 204 and the fixed guide shaft 202 reduces the adverse effects of the wiring 344a and 344b on the paths of the electron beams. This improves the exposure precision of the electron-beam exposure apparatus 100. Note that a magnetic shield is preferably formed so as to surround the wiring 344a and 344b, regardless of whether or not the wiring 344a and 344b are embedded within the fixed guide shaft 202.

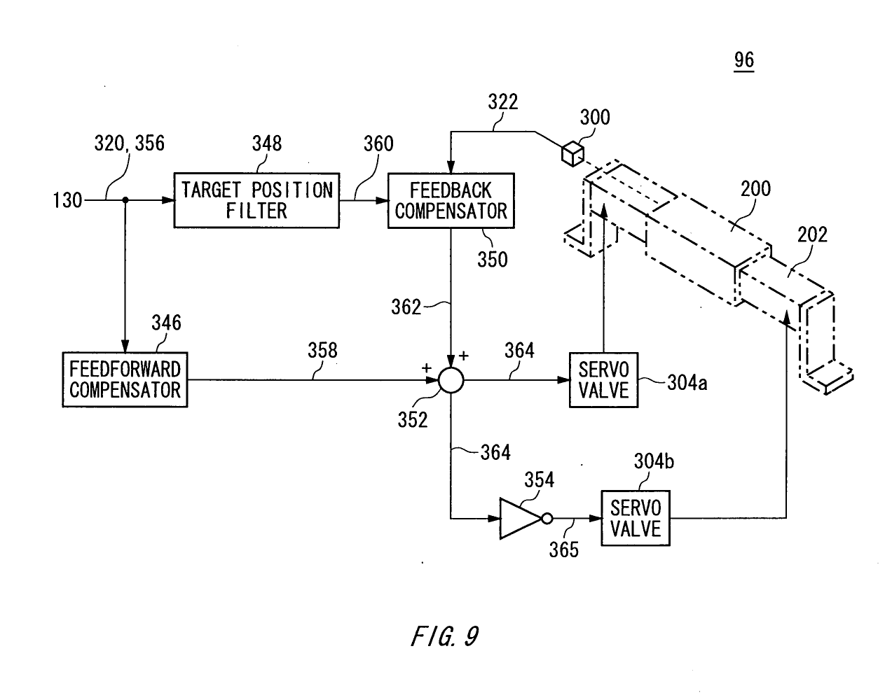

FIG. 9 shows a fourth example of the configuration of the wafer stage control unit 96 according to the present embodiment. The wafer stage control unit 96 according to the present example includes: the movable-slider position sensor 300 for detecting the position of the movable slider 200; the servo valves 304a and 304b for driving the movable slider 200; a feedforward compensator 346 for calculating the feedforward driving amount which is the driving amount of the movable slider 200 and which is to be generated by the servo valves 304a and 304b; a target position filter 348 for filtering the target position signal 320 indicating the target position to which the movable slider 200 is to be moved; a feedback compensator 350 for calculating the feedback driving amount which is the driving amount of the movable slider 200 due to the servo valves 304a and 304b; and an adder 352 for summing up the feedforward driving amount and the feedback driving amount, and supplying the sum to the servo valves 304a and 304b.

The feedforward compensator 346 acquires a start position signal 356 indicating the start position of the movable slider 200, from the central control unit 130 or the movable-slider position sensor 300. Furthermore, the feedforward compensator 346 acquires the target position signal 320 indicating the target position to which the movable slider 200 is to be moved, from the central control unit 130. Then, the feedforward-compensator 346 calculates and outputs a feedforward compensation opening signal 358 indicating the opening of the servo valves 304a and 304b, as a feedforward driving amount, over the period of time during the movement of the movable slider 200 from the start position up to the target position based upon the start position of the movable slider 200 and the target position to which the movable slider 200 is to be moved.

Specifically, the feedforward compensator 346 calculates the opening of the servo valves 304a and 304b using a composite function. Here, the composite function is formed of: a function for calculating the position of the movable slider 200 from the point in time; and a function for calculating the opening of the servo valves 304a and 304b corresponding to the driving amounts due to the servo valves 304a and 304b from the position of the movable slider 200.

For example, with the feedforward compensator 346, the inverse transfer function (2) of the transfer function (1) for the pneumatic actuator is employed.

$$\begin{matrix}\frac{x}{{S}_{e}} = \frac{{K}_{n} {ω}_{n}^{2}}{( s + {ω}_{s} ) ( {s}^{2} + 2 ζ {ω }_{n} + {ω}_{n}^{2} )} & ( 1 ) \\ \frac{{S}_{e}}{x} = ( \frac{( s + {ω}_{s} ) ( {s}^{2} + 2 ζ {ω}_{n} + {ω}_{n}^{2} )}{{K}_{n} {ω}_{n}^{2}} ) & ( 2 )\end{matrix}$$

Here, x represents the target position to which the movable slider 200 is to be moved, Kₙ represents the opening constant, ω_{S} represents the time constant of Kₙ, ωₙ represents the natural frequency, ζ represents the damping coefficient, and s represents the Laplacian operator.

Here, the inverse transfer function (2) for the pneumatic actuator is not proper. That is to say, with regard to this function in the Laplace space, the inversion of Laplace transform thereof creates a divergent function. Accordingly, it is difficult to calculate the opening of the servo valves 304a and 304b from the ideal position of the movable slider 200. With the present embodiment, the feedforward compensator 346 employs a composite function in which the inversion of Laplace transform thereof creates a convergent function. Specifically, the composite function is created using the function represented by (3), for example.

$$\frac{x}{{x}_{r}} = \frac{γ}{{s}^{3} + α {s}^{2} + β s + γ} \qquad ( 3 )$$

Here, xᵣ represents the ideal position of the movable slider 200, and α, β, and γ, are coefficients determined by properties of the pneumatic actuator and the environment.

Thus, the feedforward compensator 346 calculates the opening of the servo valves 304a and 304b using the following composite function (4) created by multiplying the aforementioned function (3) by the inverse transfer function of the pneumatic actuator represented by (2).

$$\frac{x}{{x}_{r}} = \frac{γ}{{s}^{3} + α {s}^{2} + β s + γ} \qquad ( 4 )$$

The target position filter 348 acquires the start position signal 356 indicating the start position of the movable slider 200, from the central control unit 130 or the movable-slider position sensor 300. Furthermore, the target position filter 348 acquires the target position signal 320 indicating the target position to which the movable slider 200 is to be moved, from the central control unit 130. Then, the target position filter 348 calculates and outputs a filtering target position signal 360 indicating the filtering target position which is the ideal position of the movable slider 200 over the period of time during the movement of the movable slider 200 from the start position up to the target position based the start position of the movable slider 200 and the target position to which the movable slider 200 is to be moved.

Specifically, the target position filter 348 calculates the filtering target position which is the ideal position of the movable slider 200 over the period of time during the movement of the movable slider 200 from the start position up to the target position using a function in the same form of the function (3) for creating a composite function in which the inversion of Laplace transform thereof creates a convergent function.

The feedback compensator 350 acquires the filtering target position signal 360 calculated by the target position filter 348, from the target position filter 348 over the period of time during the movement of the movable slider 200 from the start position up to the target position. Furthermore, the feedback compensator 350 acquires the movable-slider position signal 322 indicating the position of the movable slider 200 detected by the movable-slider position sensor 300, over the period of time during the movement of the movable slider 200 from the start position up to the target position. Then, the feedback compensator 350 calculates and outputs a feedback compensation opening signal 362 indicating the opening of the servo valves 304a and 304b, which is a feedback driving amount, over the period of time during the movement of the movable slider 200 from the start position up to the target position based upon the filtering target position and the position of the movable slider 200.

The adder 352 acquires the feedforward compensation signal 358 from the feedforward compensator 346. Furthermore, the adder 352 acquires the feedback compensation opening signal 362 from the feedback compensator 350. Then, the adder 352 sums up the feedforward compensation opening signal 358 and the feedback compensation opening signal 362 and outputs the sum as a servo valve opening signal 364 indicating the opening of the servo valve 304a and 304b.

The servo valve 304a acquires the servo valve opening signal 364 calculated by the adder 352, from the adder 352. Then, the servo valve 304a adjusts introduction/discharge of compressed air into/from the cylinder chamber 206a corresponding to the opening of the servo valve 304a according to the servo valve opening signal 364 acquired from the adder 352. On the other hand, the servo valve 304b acquires a servo valve opening instruction value 365 from an inverter 354. Here, the servo valve opening instruction value 365 output from the inverter 354 is an inverted signal of the servo valve opening signal 364 calculated by the adder 352. Thus, the servo valve 304b adjusts introduction/discharge of compressed air into/from the cylinder chamber 206b corresponding to the opening of the servo valve 304b according to the servo valve opening signal 365 acquired from the inverter 354.

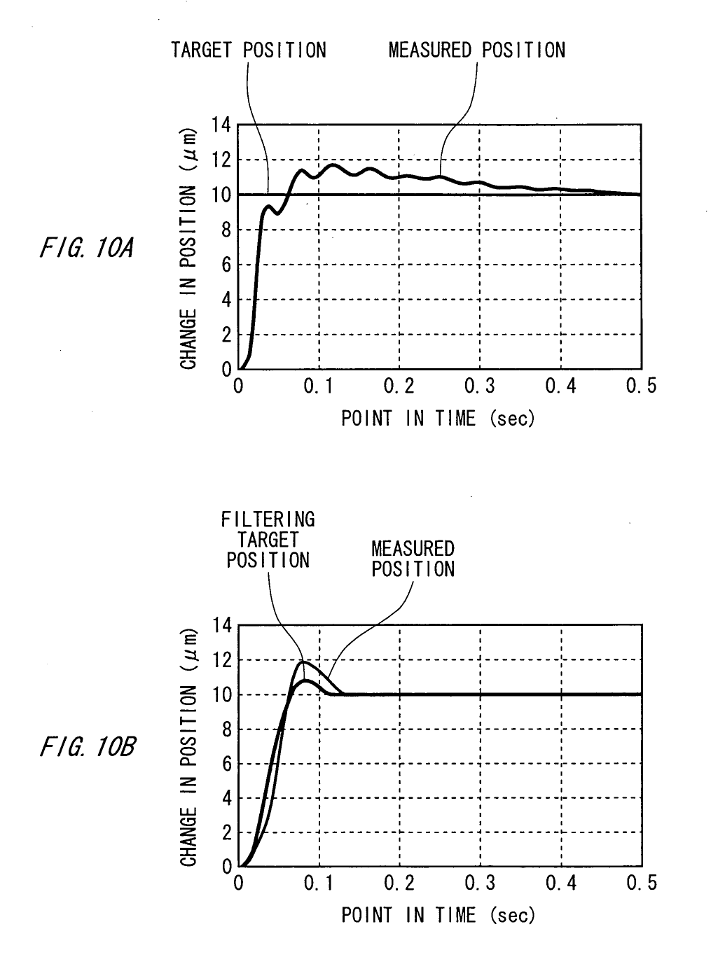

FIG. 10 shows an example of the relation between the change in the position of the movable slider 200 and the point in time according to the fourth example of the present invention. FIG. 10(a) shows the target position of the movable slider 200 input to the feedback compensator 350 and the measured position of the movable slider 200 obtained using an arrangement including the components shown in FIG. 9, except for the feedforward compensator 346 and the target position filter 348. FIG. 10(b) shows the target position of the movable slider 200 input to the feedback compensator 350 and the measured position of the movable slider 200 obtained using an arrangement including all the components shown in FIG. 9.

As shown in FIG. 10(a), with the wafer stage control unit 96 which does not have the feedforward compensator 346 and the target position filter 348, convergence of the measured position of the movable slider 200 to the target position (10 μm) requires approximately 0.5 sec. On the other hand, as shown in FIG. 10(b), with the wafer stage control unit 96 shown in FIG. 9, convergence of the measured position of the movable slider 200 to the target position (10 μm) requires only approximately 0.13 sec.

With the wafer stage control unit 96 according to the present example, the opening of the servo valves 304a and 304b is controlled by the feedforward compensator 346 and the feedback compensator 350. This facilitates convergence of the position of the movable slider 200 to the target position. This improves the control performance of the wafer stage 46, thereby improving the exposure precision of the electron-beam exposure apparatus 100.

Also, the wafer stage control unit 96 according to a fifth example of the present embodiment may have a configuration which is a combination of the configuration of the wafer stage control unit 96 according to the first example shown in FIG. 1 and the configuration of the wafer stage control unit 96 according to the fourth example shown in FIG. 9. That is to say, an arrangement according to the present example may include the feedback compensator 350 shown in FIG. 9 further including the movable-slider position compensator 306 shown in FIG. 4. With such an arrangement, the feedback driving amount may be calculated based upon the target position to which the movable slider 200 is to be moved, the position of the movable slider 200 detected by the movable-slider position sensor 300, and the acceleration of the movable slider 200 detected by the acceleration sensor 302.

Also, the wafer stage control unit 96 according to a sixth example of the present embodiment may have a configuration which is a combination of the configuration of the wafer stage control unit 96 according to the third example shown in FIG. 7 and the configuration of the wafer stage control unit 96 according to the fourth example shown in FIG. 9. That is to say, an arrangement according to the present example may include the feedback compensator 350 shown in FIG. 9 further including the movable-slider position compensator 306 and the pressure compensators 338a and 338b shown in FIG. 7. With such an arrangement, the feedback driving amount may be calculated based upon the target position to which the movable slider 200 is to be moved, the position of the movable slider 200 detected by the movable-slider position sensor 300, and the pressure in the two cylinder chambers 206a and 206b detected by the two pressure sensors 336a and 336b, respectively.

The electron-beam exposure apparatus 100 according to the present embodiment has a configuration which eliminates the factors reducing the control performance due to computation processing for the acceleration of the movable slider 200. This improves responsivity to change in the pressure in the cylinder chambers 206a and 206b. Furthermore, this facilitates convergence of the position of the movable slider 200 to the target position. Thus, this improves the control performance of the wafer stage 46, thereby improving the exposure precision of the electron-beam exposure apparatus 100.

While description has been made regarding the present invention with reference to the embodiments, the technical scope of the present invention is not restricted to the embodiments described above. Various changes and modifications of the aforementioned embodiments may be made to carry out the present invention described in the Claims. It is needless to say that such various changes and modifications are also encompassed in the technical scope of the present invention as defined in the Claims.

As can be clearly understood from the above description, the present invention provides improved control performance of the wafer stage 46, thereby improving the exposure precision of the electron-beam exposure apparatus 100.

What is claimed is:

1. A stage apparatus for driving and moving a target object comprising:
a movable slider for mounting and moving said target object;
a movable-slider driving unit for driving said movable slider;
a feedforward compensator for calculating a feedforward driving amount which is a driving amount to be generated by said movable slider driving unit over the period of time during the movement of said movable slider from the start position up to the target position to which said movable slider is to be moved, based upon said start position and said target position;
a movable-slider position sensor for detecting the position of said movable slider;
a feedback compensator for calculating a feedback driving amount which is a driving amount to be generated by said movable slider driving unit over the period of time during the movement of said movable slider from the start position up to said target position, based upon the target position to which said movable slider is to be moved, and the position of said movable slider detected by said movable-slider position sensor.

2. A stage apparatus according to claim 1, further comprising a target position filter for calculating the filtering target position which is an ideal position of said movable slider driving unit over the period of time during the movement of said movable slider from said start position up to said target position based upon said start position of said movable slider and said target position to which said movable slider is to be moved,
and wherein said feedback compensator calculates said feedback driving amount over the period of time during the movement of said movable slider from said start position up to said target position based upon said filtering target position calculated by said target position filter and the position of said movable slider detected by said movable-slider position sensor.

3. A stage apparatus according to claim 2, wherein said feedforward compensator calculates said feedforward driving amount using a composite function formed of a first function for calculating the position of said movable slider from the point in time, and a second function for calculating a driving amount to be generated by said movable slider driving unit from the position of said movable slider, and wherein said second function is represented by a function in the Laplace space in which the inversion of Laplace transform thereof creates a divergent function, and wherein said first function is represented by a function for creating said composite function in which the inversion of Laplace transform thereof creates a convergent function,
and wherein said target position filter calculates a filtering target position which is the position of said movable slider driving unit over the period of time during the movement of said movable slider from said start position up to said target position using said first function.

4. A stage apparatus according to claim 1, further comprising an acceleration sensor provided to said movable slider for detecting the acceleration of said movable slider, wherein said feedback compensator calculates said feedback driving amount based upon the target position to which said movable slider is to be moved, the position of said movable slider detected by said movable-slider position sensor, and said acceleration of said movable slider detected by said acceleration sensor.

5. A stage apparatus according to claim 1, further comprising:
a fixed guide shaft for guiding said movable slider;
a pressure plate provided between said movable slider and said fixed guide shaft;
two cylinder chambers formed by said movable slider and said fixed guide shaft so as to be arranged in the horizontal direction with said pressure plate introduced therebetween; and
two pressure sensors for detecting the pressures in said two cylinder chambers,
wherein said feedback compensator calculates said feedback driving amount based upon the target position to which said movable slider is to be moved, the position of said movable slider detected by said movable-slider position sensor, and said pressures in said two cylinder chambers detected by said two pressure sensors, respectively.

6. An electron-beam exposure apparatus for exposing a wafer comprising:
a stage apparatus for mounting and moving said wafer; and
an exposure unit for exposing said wafer mounted on said stage apparatus,
wherein said stage apparatus including
a movable slider for mounting and moving said wafer,
a movable-slider driving unit for driving said movable slider,
a feedforward compensator for calculating a feedforward driving amount which is a driving amount to be generated by said movable slider driving unit over the period of time during the movement of said movable slider from the start position up to the target position to which said movable slider is to be moved, based upon said start position and said target position,
a movable-slider position sensor for detecting the position of said movable slider, and
a feedback compensator for calculating a feedback driving amount which is a driving amount to be generated by said movable slider driving unit over the period of time during the movement of said movable slider from the start position up to said target position, based upon the target position to which said movable slider is to be moved, and the position of said movable slider detected by said movable-slider position sensor.

7. A stage apparatus for driving and moving a target object comprising:
a movable slider for mounting and moving said target object;
a movable slider driving unit for driving said movable slider;
a movable-slider position sensor for detecting the position of said movable slider;
an acceleration sensor provided to said movable slider for detecting the acceleration of said movable slider; and
a movable-slider position compensator for controlling the driving amount generated by said movable slider driving unit, based upon the target position to which said movable slider is to be moved, the position of said movable slider detected by said movable-slider position sensor, and said acceleration of said movable slider detected by said acceleration sensor.

8. A stage apparatus according to claim 7, further comprising:
a fixed guide shaft for guiding said movable slider;
a pressure plate provided between said movable slider and said fixed guide shaft; and
two cylinder chambers which is formed by said movable slider and said fixed guide shaft so as to be arranged in the horizontal direction with said pressure plate introduced therebetween, and which allows movement of said movable slider along said fixed guide shaft by controlling the internal pressure using said movable slider driving unit, wherein said acceleration sensor is provided within either of said two cylinder chambers.

9. A stage apparatus according to claim 8, wherein wiring for electrically connecting said acceleration sensor and said movable-slider position compensator is embedded within said fixed guide shaft.

10. A stage apparatus according to claim 7, further comprising an image analysis unit for capturing an image and performing image analysis,
wherein said acceleration sensor displays said acceleration of said movable slider thus detected, and wherein said image analysis unit captures an image of said acceleration of said movable slider displayed by said acceleration sensor and performs image analysis so as to obtain said acceleration of said movable slider and output said acceleration to said movable-slider position compensator.

11. An electron-beam exposure apparatus for exposing a wafer comprising:
a stage apparatus for mounting and moving said wafer; and an exposure unit for exposing said wafer mounted on said stage apparatus,
wherein said stage apparatus including
a movable slider for mounting and moving said wafer,
a movable-slider driving unit for driving said movable slider,
a movable-slider position sensor for detecting the position of said movable slider,
an acceleration sensor provided to said movable slider for detecting the acceleration of said movable slider, and
a movable-slider position compensator for controlling the driving amount to be generated by said movable slider driving unit, based upon the target position to which said movable slider is to be moved, the position of said movable slider detected by said movable-slider position sensor, and said acceleration of said movable slider detected by said acceleration sensor.

12. A stage apparatus for driving and moving a target object comprising: a movable slider for mounting and moving said target object;
a fixed guide shaft for guiding said movable slider;
a pressure plate provided between said movable slider and said fixed guide shaft;
two cylinder chambers formed by said movable slider and said fixed guide shaft so as to be arranged in the horizontal direction with said pressure plate introduced therebetween;
a movable-slider driving unit for driving said movable slider along said fixed guide shaft by controlling the pressures in said two cylinder chambers;
a movable-slider position sensor for detecting the position of said movable slider;
two pressure sensors for detecting the pressures in said two cylinder chambers, respectively; and
a pressure compensator for controlling the driving amount to be generated by said movable-slider driving unit based upon the target position to which said movable slider is to be moved, the position of said movable slider detected by said movable-slider position sensor, and said pressures in said two cylinder chambers detected by said two pressure sensors, respectively.

13. A stage apparatus according to claim 12, wherein said two pressure sensors are provided within said two cylinder chambers, respectively.

14. A stage apparatus according to claim 13, wherein said two pressure sensors are fixed on both the left and right faces of said pressure plate.

15. A stage apparatus according to claim 13, wherein wiring for electrically connecting said pressure sensor and said pressure compensator is embedded within said fixed guide shaft.

16. An electron-beam exposure apparatus for exposing a wafer comprising:
a stage apparatus for mounting and moving said wafer; and an exposure unit for exposing said wafer mounted on said stage apparatus,
wherein said stage apparatus including
a movable slider for mounting and moving said wafer,
a fixed guide shaft for guiding said movable slider,
a pressure plate provided between said movable slider and said fixed guide shaft,
two cylinder chambers formed by said movable slider and said fixed guide shaft so as to be arranged in the horizontal direction with said pressure plate introduced therebetween,
a movable-slider driving unit for driving said movable slider along said fixed guide shaft by controlling the pressures in said two cylinder chambers,
a movable-slider position sensor for detecting the position of said movable slider,
two pressure sensors for detecting the pressures in said two cylinder chambers, respectively, and
a pressure compensator for controlling the driving amount to be generated by said movable-slider driving unit based upon the target position to which said movable slider is to be moved, the position of said movable slider detected by said movable-slider position sensor, and said pressures in said two cylinder chambers detected by said two pressure sensors, respectively.
